(19) United States
(12) Patent Application Publication
(10) Pub. No.: US 2015/0085615 A1
(43) Pub. Date: Mar. 26, 2015

(54) MOTION MODIFIED STEERING VECTOR

(71) Applicant: LENOVO (Singapore) PTE, LTD., New Tech Park (SG)

(72) Inventors: Steven Richard Perrin, Raleigh, NC (US); John Miles Hunt, Raleigh, NC (US); Jian Li, Chapel Hill, NC (US); John Weldon Nicholson, Cary, NC (US); Song Wang, Cary, NC (US); Jianbang Zhang, Raleigh, NC (US)

(73) Assignee: LENOVO (Singapore) PTE, LTD., New Tech Park (SG)

(21) Appl. No.: 14/036,361

(22) Filed: Sep. 25, 2013

(51) Int. Cl. G01S 3/802

(52) U.S. Cl. CPC G01S 3/8027
USPC 367/129

(57) ABSTRACT

For a motion modified steering vector, a motion module modifies a prior steering vector with a motion vector. A steering module spatially filters audio signals using the modified steering vector.

### FIELD

The subject matter disclosed herein relates to steering vectors and more particularly relates to motion modified steering vectors.

### BACKGROUND

### Description of the Related Art

A steering vector may be calculated to an audible source so that a spatial filter based on the steering vector may be applied to audible signals from the source to enhance the audible signals. Unfortunately, a microphone array receiving the audible signals may move, reducing the effectiveness of the steering vector.

### BRIEF SUMMARY

An apparatus for motion modified steering vector is disclosed. The apparatus includes a microphone array, a motion sensor, a processor, and a memory. The memory stores computer readable code that includes a motion module and a steering module. The motion module modifies a prior steering vector with a motion vector. The steering module spatially filters audio signals using the modified steering vector. A method and computer program product also perform the functions of the apparatus.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a microphone array;

FIGS. 2A-C are schematic block diagrams illustrating embodiments of microphone arrays;

FIGS. 3A-B are perspective drawings illustrating embodiments of electronic devices;

FIG. 4 is a schematic diagram illustrating one embodiment of spatial filtering;

FIGS. 5A-B are schematic diagrams illustrating embodiments of moving microphone arrays;

FIG. 6 is a schematic block diagram illustrating one embodiment of an audio channel;

FIG. 7 is a perspective drawing illustrating one embodiment of microphone array and audible source geometries;

FIG. 8 is a schematic block diagram illustrating one embodiment of an electronic device;

FIG. 9 is a schematic block diagram illustrating one embodiment of the steering vector apparatus;

FIG. 10 is a schematic flow chart diagram illustrating one embodiment of a steering vector modification method; and

FIG. 11 is a schematic flow chart diagram illustrating one alternate embodiment of a steering vector modification method.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing computer readable code. The storage devices may be tangible, non-transitory, and/or non-transmission.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in computer readable code and/or software for execution by various types of processors. An identified module of computer readable code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices, and may exist, at least partially, merely as electronic signals on a system or network. Where a module or portions of a module are implemented in software, the software portions are stored on one or more computer readable storage devices.

Any combination of one or more computer readable medium may be utilized. The computer readable medium may be a computer readable signal medium or a storage device. The computer readable medium may be a storage device storing the computer readable code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable code embodied therein, for example, in baseband or as part of a carrier wave. Such a propagated signal may take any of a variety of forms, including, but not limited to, electro-magnetic, optical, or any suitable combination thereof. A computer readable signal medium may be any storage device that is not a computer readable storage medium and that can communicate, propagate, or transport a program for use by or in connection with an instruction execution system, apparatus, or device. Computer readable code embodied on a storage device may be transmitted using any appropriate medium, including but not limited to wireless, wire line, optical fiber cable, Radio Frequency (RF), etc., or any suitable combination of the foregoing.

Computer readable code for carrying out operations for embodiments may be written in any combination of one or more programming languages, including an object oriented programming language such as Java, Smalltalk, C++ or the like and conventional procedural programming languages, such as the “C” programming language or similar programming languages. The computer readable code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by computer readable code. These computer readable code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer readable code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The computer readable code may also be loaded onto a computer, other programmable data processing apparatus, or other devices to cause a series of operational steps to be performed on the computer, other programmable apparatus or other devices to produce a computer implemented process such that the program code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable code.

Descriptions of Figures may refer to elements described in previous Figures, like numbers referring to like elements.

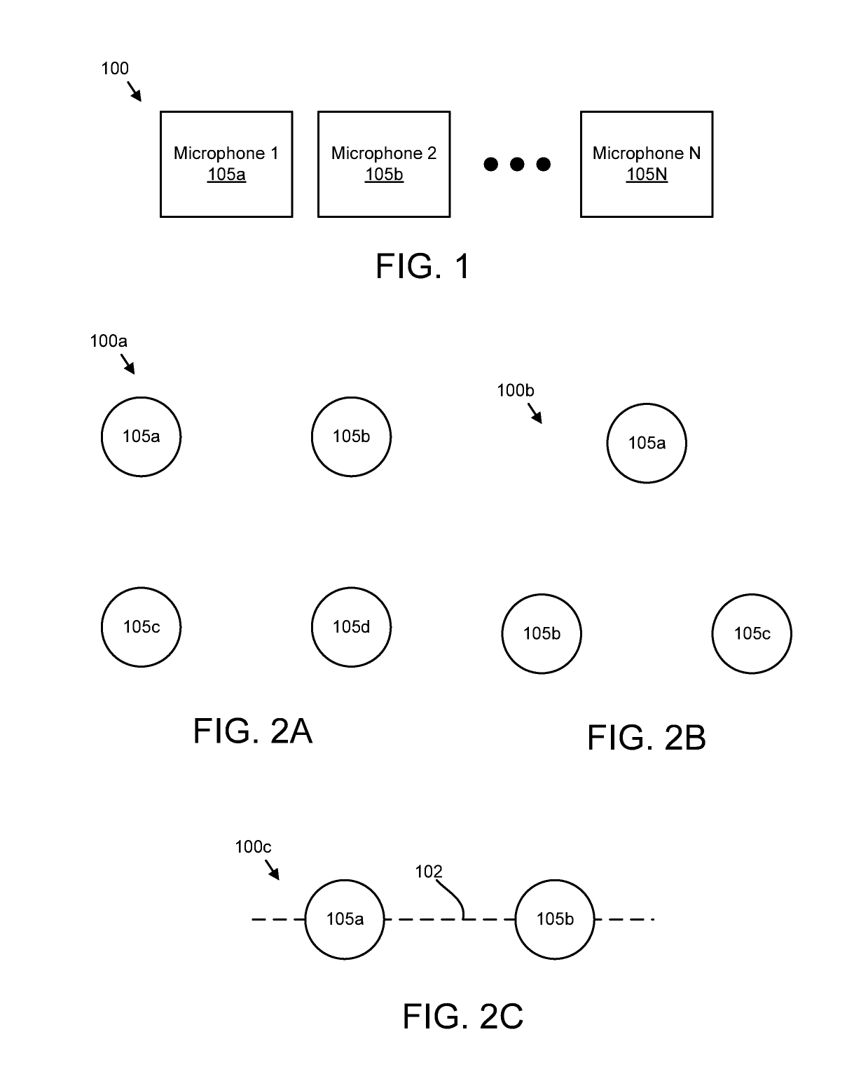

FIG. 1 is a schematic block diagram illustrating one embodiment of a microphone array 100. The microphone array 100 may include two or more microphones 105. In one embodiment, the microphones 105 are organized in a planar array.

FIGS. 2A-C are schematic block diagrams illustrating embodiments of microphone arrays 100a-c. The microphone arrays 100a-c include two to four microphones 105 and are organized in various geometries, including a square geometry as in FIG. 2A, a triangular geometry as in FIG. 2B, and a linear geometry as in FIG. 2C. In one embodiment, the microphones 105 are disposed along a common axis 102.

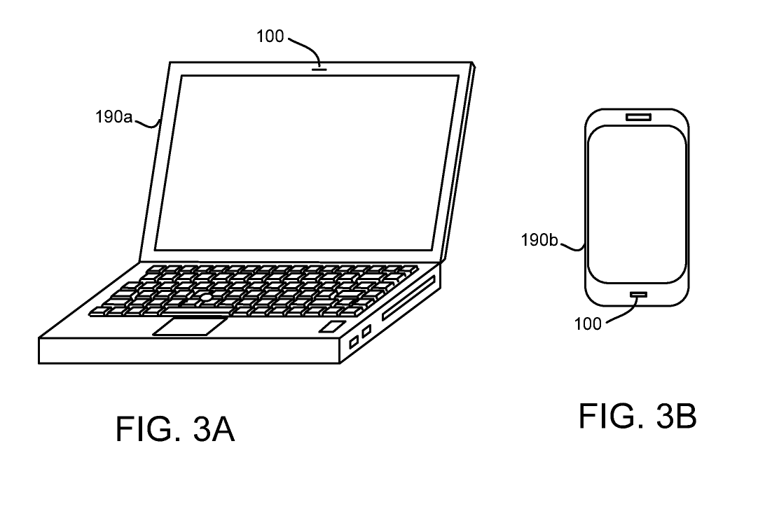

FIGS. 3A-B are perspective drawings illustrating embodiments of electronic devices 190. FIG. 3A depicts a laptop computer electronic device 190a with a microphone array 100. FIG. 3B shows a mobile telephone electronic device 190b with a microphone array 100. One of skill in the art will recognize that the embodiments may be practiced with other electronic devices 190 including but not limited to computer workstations, tablet computers, eyeglass computers, wearable computers, and the like.

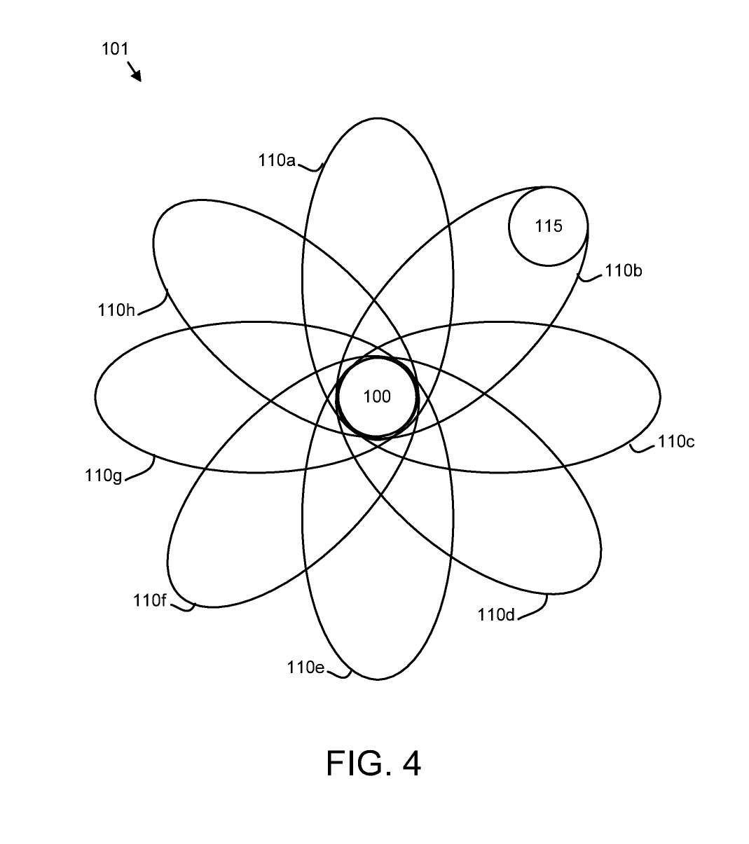

FIG. 4 is a schematic diagram illustrating one embodiment of spatial filtering 101. Spatial filtering, as referred to as beamforming, is applied to the audio signals from a microphone array 100 to produce a plurality of receiving gain areas 110. Within the receiving gain area 110, the signal-to-noise ratio of an audible signal received by the microphone array 100 is increased. A steering vector for the spatial filtering is adjusted to define the direction of the spatial filtering and the receiving gain area 110. In the depicted embodiment, the steering vector for a second receiving gain area 110b is selected to enhance the signal-to-noise ratio of an audible signal received from an audible source 115.

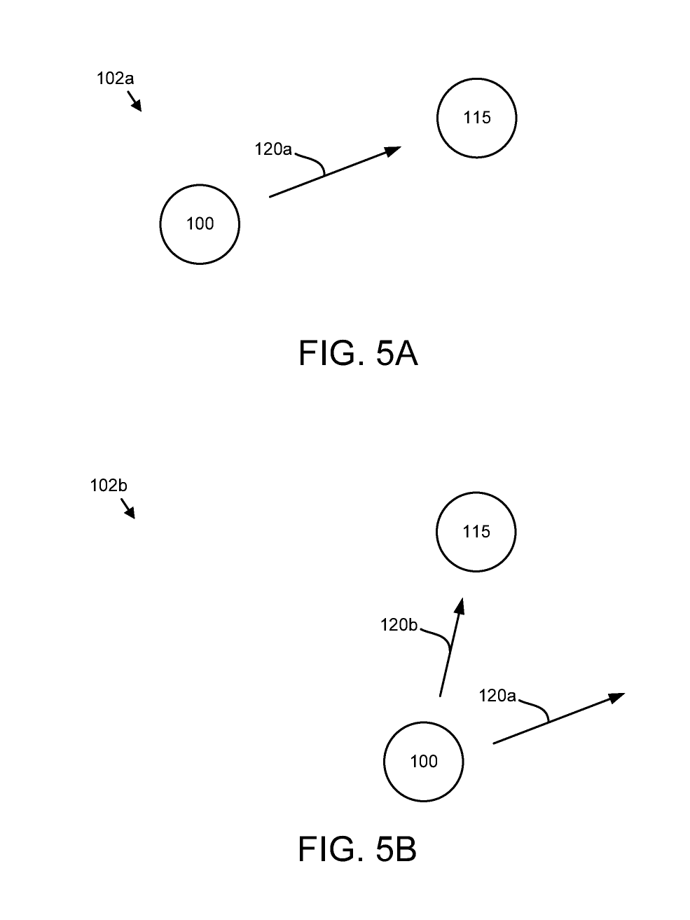

FIGS. 5A-B are schematic diagrams illustrating embodiments of moving microphone arrays 100. In FIG. 5A a first steering vector 120a is directed from the microphone array 100 to the audible source 115. FIG. 5B depicts the microphone array 100 and the audible source 115 of FIG. 5A after the microphone array 100 has moved. The first steering vector 120a is no longer directed to the audible source 115. As a result, spatial filtering using the first steering vector 120a would be much less efficient to increase the signal-to-noise ratio for the audible signals from the audible source 115 than a second steering vector 120b that is directed more accurately to the audible source 115.

The embodiments described herein modify a prior steering vector with a motion vector to generate a modified steering vector 120. The modified steering vector 120 may then be employed to more effectively spatially filter audible signals from an audible source 115 as will be described hereafter.

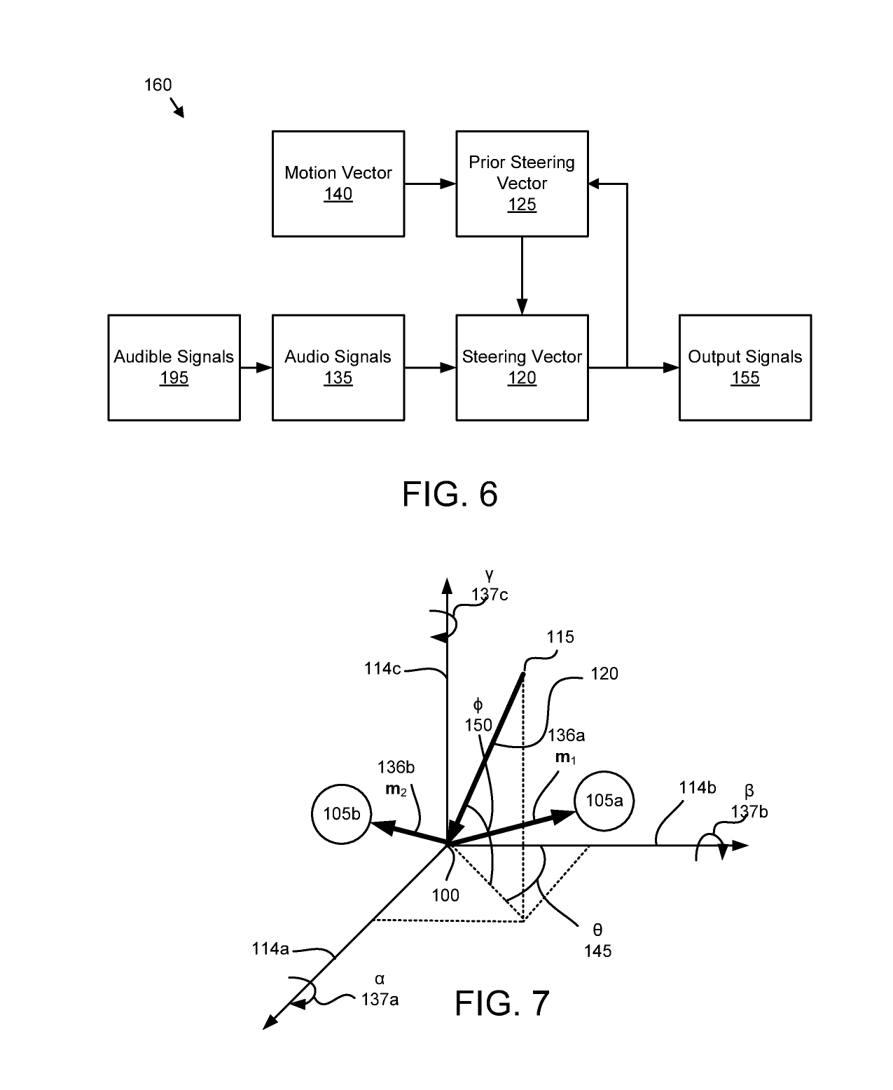

FIG. 6 is a schematic block diagram illustrating one embodiment of an audio channel 160. The audio channel 160 includes audible signals 195, audio signals 135, the steering vector 120, output signals 155, a motion vector 140, and a prior steering vector 125. The audible signals 195 are received by the microphone array 100. The audible signals 195 are converted into electrical audio signals 135. The audio signals 135 may be digital audio signals 135 or analog audio signals 135. The steering vector 120 may be applied to the audio signals 135 as part of a spatial filter to generate output signals 155.

Unfortunately as was illustrated in FIGS. 5A-B, when the microphone array 100 moves, either in translation, rotation, or combinations thereof, the steering vector 120 is less effective for spatial filtering. However, the present embodiments apply the motion vector 140 for the microphone array 100 to the prior steering vector 125 to generate a modified steering vector 120. As a result, the steering vector 120 is adjusted for the motion of the microphone array 100, so that spatial filtering is more effective despite the motion of the microphone array 100.

FIG. 7 is a perspective drawing illustrating one embodiment of microphone array 100 and audible source 115 geometries. A steering vector k 120 is shown from an audible source 115 to a microphone array 100. The microphone array 100 is depicted at an origin of mutually orthogonal axes 114. The steering vector k 120 is defined by two angles, θ 145 and φ 150, relative to the origin of the mutually orthogonal axes 114, where the steering vector k 120 is given by Equation 1.

$$k = \begin{matrix}cos ϕ sin θ \\ cos ϕ cos θ \\ sin ϕ\end{matrix} \qquad Equation 1$$

A first microphone 105a of the microphone array 100 is disposed at vector m₁ 136a and the second microphone 105b is disposed at vector m₂ 136b. The delays d for spatial filtering for the microphones 105 may be calculated using Equation 2.

d=(m₂−m₁)^{T}k Equation 2

When the microphone array 100 is moved, the microphone array 100 may be rotated relative to the audible source 115. The rotation of the microphone array 100 is calculated using the matrices of Equation 3, where α 137a is rotation about a first axis 114a, β 137b is a rotation about a second axis 114b, and γ 137c is a rotation about a third axis 114c.

$${R}_{x} ( α ) = \begin{matrix}1 & 0 & 0 \\ 0 & cos α & - sin α \\ 0 & sin α & cos α\end{matrix} \\ {R}_{y} ( β ) = \begin{matrix}cos β & 0 & sin β \\ 0 & 1 & 0 \\ - sin β & 0 & cos β\end{matrix} \\ {R}_{z} ( γ ) = \begin{matrix}cos γ & - sin γ & 0 \\ sin γ & cos β & 0 \\ 0 & 0 & 1\end{matrix} \qquad Equation 3$$

A rotation matrix R may be defined as shown in Equation 4. The rotation matrix R may be the motion vector MV 140.

R=Rₓ(α)R_{y}(β)R_{z}(γ) Equation 4

The motion vector 140 may be applied to the steering vector 120 to adjust the delays for the microphones 105 of the microphone array 100 and shown in Equation 5.

d=MV(m₂−m₁)^{T}k Equation 5

Alternatively, the motion vector 140 may be applied to the prior steering vector 125 to calculate a modified steering vector 120 as shown in Equation 6

MS=MV*SV0 Equation 6

Thus the audio signals 135 are filtered with the modified steering vector 120 that more accurately reflects the position of the audible source 115.

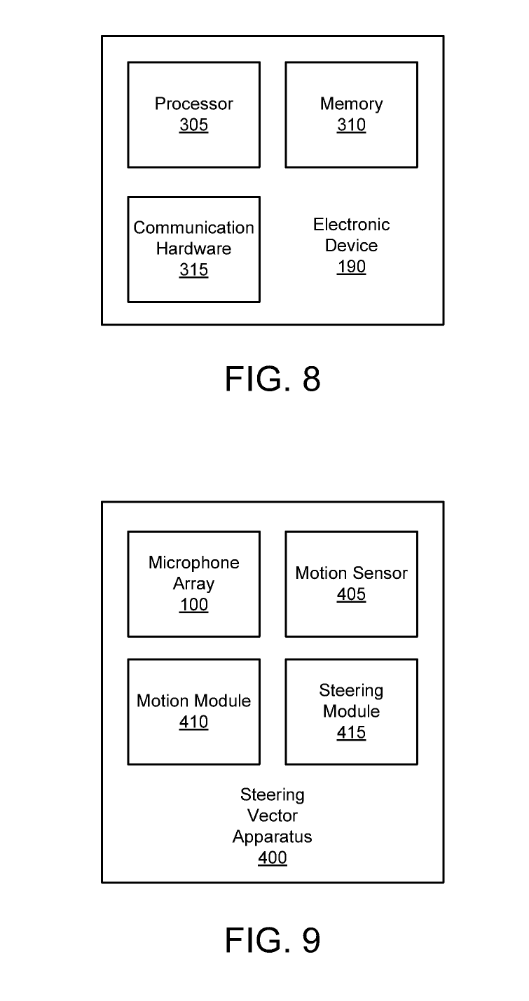

FIG. 8 is a schematic block diagram illustrating one embodiment of an electronic device 190. The electronic device 190 includes a processor 305, a memory 310, and communication hardware 315. The processor 305 may be a digital signal processor. The memory 310 may be a semiconductor storage device, a hard disk drive, an optical storage device, a micromechanical storage device, or combinations thereof. The memory 310 stores computer readable code. The processor 305 may execute the computer readable code. The communication hardware 315 may communicate with other devices.

FIG. 9 is a schematic block diagram illustrating one embodiment of the steering vector apparatus 400. The apparatus 400 may be embodied in the electronic device 190. The apparatus 400 includes the microphone array 100, a motion sensor 405, a motion module 410, and a steering module 415. The motion module 410 and the steering module 415 may be embodied in a computer readable storage medium such as the memory 310.

The motion sensor 405 may be an accelerometer measuring accelerations in one or more axes. Alternatively, the motion sensor 405 may be a gyroscope measuring changes in orientation. The rotation matrix R may be calculated from the changes in orientation and/or from the accelerations.

The motion module 410 may modify the prior steering vector 125 with the motion vector 140. The steering module 415 may spatially filter the audio signals 135 using the modified steering vector 120.

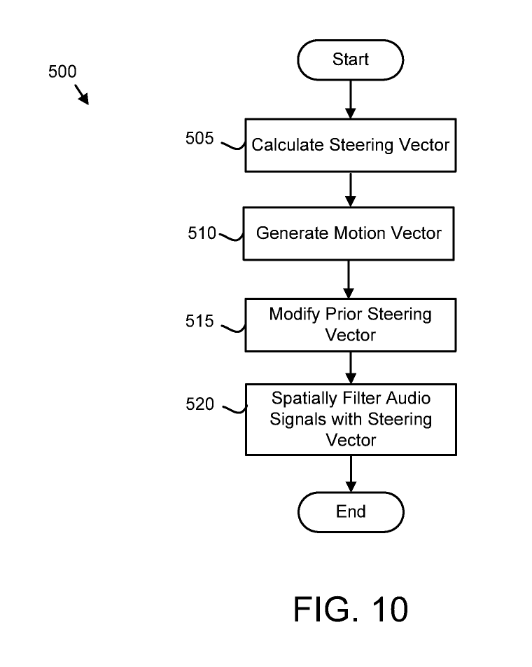

FIG. 10 is a schematic flow chart diagram illustrating one embodiment of a steering vector modification method 500. The method 500 may perform the functions of the apparatus 400 and electronic device 190. The method 500 may be performed by the processor 305. Alternatively, the method 500 may be performed by a program product. The program product may include a computer readable storage medium such as the memory 310 storing computer readable code that is executed by the processor 305.

The method 500 starts, and in one embodiment, the motion module 410 calculates 505 the steering vector 120. In one embodiment, the motion module 410 may calculate a signal strength for the audio signals 135 at each of a plurality of trial steering vectors 120. For example, the motion module 410 may generate trial steering vectors 120 for a sphere of θ 145 plus 0 to 360° and φ 150 plus 0 to 180°. The motion module 410 may select the trial steering vector 120 with the greatest signal strength as the steering vector 120.

The motion module 410 may further generate 510 the motion vector 140. The motion vector 140 may estimate all motion of the microphone array 100 since the last calculation 505 of the steering vector 120. In one embodiment, the motion module 410 receives signals encoding the changes in orientation and/or acceleration from the motion sensor 405. The motion module 410 may further calculate the rotation matrix R using Equations 3 and 4. The rotation matrix R may be the motion vector 140.

The motion module 410 may further modify 515 the prior steering vector 125 with the motion vector to generate the modified steering vector 120. In one embodiment, the motion module 410 may employ Equation 6 to generate the modified steering vector 120.

The steering module 415 may spatially filter 520 the audio signals 135 using the modified steering vector 120 and the method 500 ends. In one embodiment, the steering module 415 spatially filters 520 the audio signals 135 using Equation 2, where k is the modified steering vector 120.

By modifying the prior steering vector 125 with the motion vector 140, the steering vector 120 is better oriented towards the audible source 115. As a result, the steering vector 120 may provide better spatial filtering for the audible signals 195 received from the audible source 115.

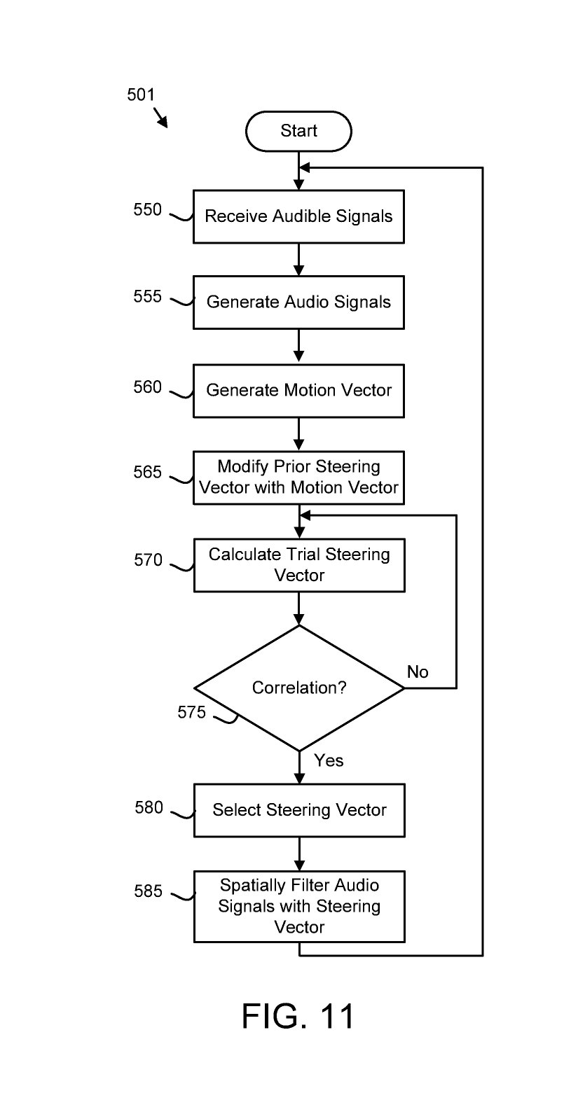

FIG. 11 is a schematic flow chart diagram illustrating one alternate embodiment of a steering vector modification method 501. The method 501 may perform the functions of the apparatus 400 and electronic device 190. The method 501 may be performed by the processor 305. Alternatively, the method 501 may be performed by a program product. The program product may include a computer readable storage medium such as the memory 310 storing computer readable code executable by the processor 305.

The method 501 starts, and in one embodiment, the microphone array 100 receives 550 audible signals 195. The microphone array 100 may further generate 555 audio signals 135 from the audible signals 195. In one embodiment, the audio signals 135 comprises an array of digitized audio values.

The motion module 410 may generate 560 the motion vector 140. In one embodiment, the motion vector 140 the rotation matrix R and may be calculated using Equations 3 and 4.

The motion module 410 may further modify 565 the prior steering vector 125 with the motion vector 140. In one embodiment, the motion module 410 may employ Equation 6 to generate the modified steering vector 120.

In one embodiment, the motion module 410 calculates one or more trial steering vectors 120. The trial steering vectors 120 may each be an angular variation of the modified steering vector 120. For example, the motion module 410 may generate trial steering vectors 120 for a hemisphere about the prior steering vector 125, for θ 145 plus 0 to 180° and φ 150 plus 0 to 90° . . . .

The motion module 410 may determine 575 which of the trial steering vectors 120 correlates with the audio signal 135. If a first trial steering vector 120 does not correlate 575 of the audio signal 135, the motion module 410 may calculate 570 another trial steering vector 120.

In one embodiment, a trial steering vector 120 that when applied to the audio signals 135 results in the highest signal strength may correlate with the audio signals 135. The trial steering vector 120 that correlates with the audio signals 135 may have a greatest effect when applied to the audio signals 135 among the plurality of trial steering vectors 120.

The motion module 410 may select 580 the trial steering vector 120 that correlates with the audio signals 135 as the steering vector 120. The steering module 415 may further spatially filter 585 the audio signals 135 with the steering vector 120. The method 501 may further loop to the microphone array 100 receiving 550 the audible signals 195.

By modifying the prior steering vector 125 with the motion vector 140 to use as the basis for calculating the trial steering vectors 120, the motion module 410 calculates 570 trial steering vectors 120 that are likely closer to the ultimate value that will be determined for the steering vector 120. As a result, the motion module 410 may more rapidly, and with fewer computational resources, select 580 the steering vector 120. Therefore, the steering vector 120 the more rapidly and accurately track the audible source 115.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a microphone array;
a motion sensor;
a processor;
a memory storing computer readable code executable by the processor, the computer readable code comprising:
a motion module modifying a prior steering vector with a motion vector; and
a steering module spatially filtering audio signals using the modified steering vector.

2. The apparatus of claim 1, motion module further generating the motion vector using the motion sensor.

3. The apparatus of claim 1, the motion module further:
receiving audible signals from the microphone array; and
generating the audio signals from the audible signals.

4. The apparatus of claim 1, the steering module further:
calculating one or more trial steering vectors from the modified steering vector; and
calculating a current steering vector from a first trial steering vector in response to the first trial steering vector correlating with the audio signals.

5. The apparatus of claim 1, wherein the modified prior steering vector MS is calculated as MS=MV*SV0 where MV is the motion vector and SV0 is the prior steering vector.

6. The apparatus of claim 1, the steering module further spatially filtering the audio signals with the modified prior steering vector to generate one or more output signals.

7. The apparatus of claim 6, wherein the output signals OS are calculated as OS=MS*IS, where MS is the modified prior steering vector and IS is a vector of the audio signals.

8. A method comprising:
modifying a prior steering vector with a motion vector; and
spatially filtering audio signals using the modified steering vector.

9. The method of claim 8, further comprising generating the motion vector using a motion sensor for a microphone array.

10. The method of claim 8, further comprising:
receiving audible signals from a microphone array; and
generating the audio signals from the audible signals.

11. The method of claim 8, further comprising:
calculating one or more trial steering vectors from the modified steering vector; and
calculating a current steering vector from a first trial steering vector in response to the first trial steering vector correlating with the audio signals.

12. The method of claim 8, wherein the modified prior steering vector MS is calculated as MS=MV*SV0 where MV is the motion vector and SV0 is the prior steering vector.

13. The method of claim 8, further comprising spatially filtering the audio signals with the modified prior steering vector to generate one or more output signals.

14. The method of claim 13, wherein the output signals OS are calculated as OS=MS*IS, where MS is the modified prior steering vector and IS is a vector of the audio signals.

15. A program product comprising a computer readable storage medium storing computer readable code executable by a processor to perform:
modifying a prior steering vector with a motion vector; and
spatially filtering audio signals using the modified steering vector.

16. The program product of claim 15, the computer readable code further generating the motion vector using a motion sensor for a microphone array.

17. The program product of claim 15, the computer readable code further:
receiving audible signals from a microphone array; and
generating the audio signals from the audible signals.

18. The program product of claim 15, the computer readable code further:
calculating one or more trial steering vectors from the modified steering vector; and
calculating a current steering vector from a first trial steering vector in response to the first trial steering vector correlating with the audio signals.

19. The program product of claim 15, wherein the modified prior steering vector MS is calculated as MS=MV*SV0 where MV is the motion vector and SV0 is the prior steering vector.

20. The program product of claim 15, the computer readable code further spatially filtering the audio signals with the modified prior steering vector to generate one or more output signals.
